(19) United States
(12) Patent Application Publication
(10) Pub. No.: US 2010/0138229 A1
(43) Pub. Date: Jun. 3, 2010

(54) IMPLEMENTING A GUIDELINE BASED CLINICAL PROCESS

(76) Inventors: Harald Mang, Mohrendorf (DE); Johann Walter, Erlangen (DE)

Correspondence Address: HARNESS, DICKEY & PIERCE, P.L.C., P.O.BOX 8910, RESTON, VA, 20195, US

(21) Appl. No.: 12/292,985

(22) Filed: Dec. 2, 2008

(51) Int. Cl. G06Q 10/00; G06Q 50/00

(52) U.S. Cl. 705/2; 705/7

(57) ABSTRACT

The invention refers to a computer-implemented method, a computerized system, a product and a computer-readable medium for implementing a clinical process, which is based on guideline data. Relevant guideline data for implementing the process is selected automatically. The architecture for the implementation process is based on designing, modelling and visualizing, wherein designing, modelling and visualizing are executed independently of each other and wherein the modelled clinical process is structured procedurally.

### TECHNICAL FIELD

The present invention generally relates to a computer-implemented method, a computerized system and a product for enhancement of a clinical process. Thus, the present invention mainly refers to the field of information technology and medical technology. Particularly, it refers to implementing a technical process, like a patient examination by means of a magnetic resonance tomography, laboratory analysis, diagnostic processes by means of a computerized system etc.

### BACKGROUND OF THE INVENTION

On the one hand modern clinical systems are normally based on a computer system and work with computerized task flows and processes. On the other hand a physician or a qualified nurse needs to take care of some processes manually. Both, the automatic processes and the manual processes need to be combined in order to generate the clinical process, being as effective as possible.

In order to enhance clinical processes it is known to work with the guidelines. The guidelines comprise all elements for a systematic generation of clinical processes: logic data, consistence analysis, evidence based medicine, decision analysis and outcome analysis. The guidelines represent the actual state of research, as they represent good practises and maybe used as a standard for medical diagnosis or therapy.

According to several research experiments it is known that quality of a clinical process might significantly be enhanced if the generation of processes is automatically supported by a computerized system. Thus, processes and clinical workflows might be optimized by means of information technological (IT) applications.

A technical system typically comprises several clinical entities that interact with other clinical entities. The clinical entities may be used by different medical professionals including nurses, doctors, physician assistants, laboratory technicians and specialists such as radiologists who all may use software tools to make decisions regarding how fast to interact with other clinical entities.

A medical professional may have a need for being supported by specific software tools to generate and possibly also to execute “his” clinical process. For the sake of quality enhancement it may be desired to let the process automatically or semi-automatically be generated in correspondence to the guidelines. If clinical processes are generated it would be helpful if the generation might be based on all available knowledge and particularly on relevant guidelines.

With respect to the guidelines it has to be mentioned that there do exist a lot of guidelines (several hundreds guidelines and more in the field of clinical systems), wherein each of them consists of several hundreds of pages of specifications and standards.

For further improvement, for example in Germany, there is a qualification, an auditing and certification of clinical guidelines in order to enhance the quality of these guidelines.

A medical professional who wants to generate a clinical process, therefore may desire to be supported by the generation of this clinical process, considering (only) relevant data from the guidelines.

Good guidelines, however, do not necessarily translate into (usable) software tools. As already stated above, guidelines have become increasingly complex, and the amount of data processed has grown to overwhelming proportions. For example, in the past it was sufficient to only use simple checklists to trigger standard medical intervention for all patients of certain age and certain gender. In contrast, nowadays, health care practitioners must consider a wide range of health risks, the presence of which can mandate changes in the content, in timing and in frequency of appropriate medical interventions. To be most effective, decision makers in all fields need practical strategies for implementing guidelines in daily practice. Particularly, they need new tools to facilitate data assessment, process documentation and individualized implementation of guidelines in a most efficient and high quality manner. A system that could actually create a useful tool, based on given guidelines to support in such generation or implementation would therefore be highly desirable.

### SUMMARY OF THE INVENTION

Abstractly stated, the present invention is a computer-implemented system that allows a medical professional to implement a clinical process which is based on guideline data.

In the following the present invention will be described in relation to the method. Any aspects, features or advantages mentioned in this respect might also be applied to other categories of the claims. These include a computerized system, a computer-readable medium and a computer program product. The system and the product and the medium might also be adapted to incorporate features that have been described in relation to the description of the method. Any functional feature of the method refers to a module of an apparatus having a particular functionality. For example the step of “selecting” refers to a “selection module” which is adapted to provide selection of items.

Particularly, the present invention relates to a computer-implemented method for implementing a clinical process according to a guideline, comprising:
providing a set of guidelines,
selecting guideline data out of the set of guidelines, being relevant for the clinical process,
designing the clinical process, based on the selected guideline data,
modeling the designed clinical process,
visualizing the modelled clinical process,
   whereby designing, modelling and visualizing are executed independently of each other and wherein the modelled clinical process is structured procedurally or workflow-oriented.

It is therefore an aspect of the present invention to provide a system and a method being efficient and effective at processing large quantities of data according to guidelines in order to implement a clinical process to be administered to a data subject wherein there is a selection of relevant guideline data out of the set of clinical guidelines.

It is also an aspect of the present invention to provide a software tool which will provide a next course of action suggestion based on the guidelines in the clinical process.

Another aspect of the present invention it to be seen in providing a qualified decision within implementation of the clinical process, being based on the guidelines.

Still another aspect of the present invention is to combine given software tools in such a manner as to implement a clinical process as efficient as possible.

Another aspect of the present invention refers to use certain repositories, which might be implemented in a data base with a plurality of business object, which could be used by designing the technical process. The repository might also be used during modelling of workflows.

Another aspect of the present invention is to combine the medical field with its medical terminology with the economical field and with economical terminology. Thus, it is one of the key aspects of the present invention that the clinical processes being implemented not only comprise medical knowledge, but additionally also comprise economical knowledge (for example in the field of accounting, ordering, materials, logistics and management, time management etc). Thus, there are not only represented clinical paths but also financial aspects or alike.

Yet another technical aspect relates to techniques for visualizing the clinical process. A well-known client-server systems could be used, so that a clinical professional might use the system by means of a browser in order to administer the clinical process and that he is also enable to be linked with other elements which are needed for the clinical process.

With respect to the security of the system all elements of a clinical process, like roles, instructions, tools, methods, templates, workflows, IT-applications, are saved in a specific data base. The step of modelling the designed clinical process refers to a combination of these elements.

Another aspect is to be seen in that each person working with the system may be assigned to a specific role in the organisation, such that there is assignment of a user to a role. The clinical process might also be implemented role and/or user specific.

In the following there is given a short explication and definition of terms, used in this disclosure.

“Implementing” a clinical process is to be construed in the sense of generating or establishing an information technology based clinical process. A clinical process normally consists of a sequence of process steps or process elements, like a taskflow or workflow. Sometimes it is possible that different process elements or steps might be executed in parallel. Each of the process steps has to be linked to the other process steps and may lie in different fields of the clinical system. Thus, a clinical step may refer to a medical task, a diagnosis task, a therapeutic task, an economic task, an administrative task or the like. After implementation of the clinical process all actions have to be executed according to the implemented process. A clinical user is supported by the method according to the invention and is provided automatically with the relevant data (guideline data being relevant).

It is contemplated that the method and system of the present invention is suitable for implementing clinical processes, for example in the area of diagnosis or therapy. However, it also has to be stated that the process moreover might also refer to a combination of different fields, like administrative processes, economical processes and the like. As already mentioned above, a clinical process consists of a sequence of steps and might be compared to a workflow or taskflow. However, in certain situations a process might be more general than a workflow and might comprise different categories of workflows. For example, a clinical process might be the following sequence “admitting a patient to hospital”, “examining patient”, “generating a diagnosis”, “establishing a therapy for a patient with a diagnosis” and “generating a report”. In case there has to be taken several examinations, it is obvious that—if possible—these different examinations of one or different process steps might also be executed in parallel.

According to the present invention there is provided a set of guidelines, which refer to different fields of a clinical system. For example there exists a guideline for dealing with hurt or another guideline exists in the field of integrated oncology, whereas further guidelines may refer to the field of anesthesiology. Out of the set of guidelines there is selected at least one guideline being relevant for the clinical process to be implemented. A guideline consists of a plurality of guideline data. Guideline data are specific data items within a guideline. Generally, not all guideline data out of a specific guideline are relevant for the implementation of the clinical process. Therefore and according to the invention those guideline data, being relevant for the implementation are selected out of the guideline data. Thus, there are two different selection processes within the method according to the invention: one for the selection of at least one relevant guideline and one for the selection of at least one relevant data item of the selected guideline(s).

The process of implementation is modular. Thus, implementing consists of different steps: Designing, modelling and visualizing. It has to be mentioned that all these steps are executed independently of each other. In this aspect there could be reached a high degree of flexibility of the system as a whole. The approach designing—modelling—visualizing is both a design pattern and an architectural pattern used in software engineering. The pattern of designing—modelling—visualizing isolates business logic from user interface consideration (visualizing), resulting in an application where it is easier to modify either the visual appearance of the application or the underlying business rules without affecting the other.

In particular, designing is a kind of establishing or generating a framework for the process and may be compared to the general architecture of the process. The step of designing considers good practises, for example of the guidelines, and other knowledge. There do exits different principles for designing, for example business logic orientated designing, a hierarchical principle, a life cycle principle and a like.

Modelling refers to the step after designing a clinical process and refers to a lower level of construction. Modelling is more specific than designing and allows for different manners of representation. Modelling might be circumscribed with assigning the designed process (and so far only theoretically existing process) to physically existing IT modules. There are different tools for modelling known in the state of the art, for example, from the companies iGrafx® or the product ARIS of the company IDS Scheer. However, it has to be contemplated that also other process modelling tools might be used for applying the present invention.

The next step refers to visualizing a modelled clinical process. Thus, visualizing refers to a user interface of the computer-implemented method. Visualizing comprises two aspects. The first one is to be seen in a representation of the implementation process according to the computer-implemented method of the present invention. With other words, there is provided a user interface for applying or using the implementation tool. The second aspect refers to visualizing the clinical process which has to be implemented or which has been already implemented so far. Within this representation the user is able to get an overview of the actual state of the implementation process. For example it might be possible that already implemented steps of the clinical process are represented in a different way compared to those steps of the clinical process which still have to be implemented.

One of the key aspects of the present invention refers to the fact that the clinical process is structured. Preferably, the structuring is done procedurally. This means that the clinical process might be workflow—orientated or taskflow—orientated. For example the step of “admitting patient to hospital” within the clinical process might be structured in a set of different sub steps. For example sub step could be “registering patient data”, “detecting meta information with respect to the specific patient”, “detecting insurance data of the patient”, “capturing a potential diagnosis given by the patient himself”. One of the sub steps within the clinical process itself consists of sub-sub-steps so that graphically speaking there will be generated a clinical process tree.

According to a preferred embodiment of the present invention all steps are carried out automatically. However, in some specific use cases it might be useful that designing is executed manually. However, modelling and assigning guideline data to the clinical process to be implemented (or to specific elements of the clinical process to be implemented) is normally executed automatically.

Also the selection of relevant data is executed automatically by means of a parser, which parses the guideline for specific words or items according to a set of pre-configurable rules.

According to an aspect of the present invention the method is based on service orientated architecture in order to generate the process, where functionality is grouped around business processes and packaged as interoperable services. The underlying IT-infrastructure allows for different software tools to exchange data with one another as they participate in business processes. All modules or services are loosely coupled with each other and with the operating system, with program languages and with other technologies, underlying the applications. The service-orientated approach separates functions into distinct units, or services which are made accessible over a network in order that they can be combined and reused in the production of business applications. The modules or services communicate with each other by passing data from one module to another, or by coordinating an activity between two or more services. As an advantage it has to be mentioned that the system then is more flexible and easily may be modified or upgraded. Further, distributed computing and modular programming is supported.

According to another aspect of the present invention and abstractly speaking the computer-implemented method could be represented as a black box with an input and an output. The set of guidelines, the guidelines or the guideline data serve as input and the output is represented as an implementation of the clinical process in a workflow oriented form, being based on guideline data or guidelines.

According to another aspect of the present invention the output may comprise additional information. That is to say in addition to the implemented clinical process also meta information with respect to the process, standard operating procedures or specific operating instruction or any other kind of additional information might be given as output. This additional information might be useful for further processes or for a documentation of implementation process.

According to a further aspect of the present invention visualizing is done by means of a single template. This template may be used as input or output interface for transferring data. Usually, all modules of the computer system are connected via a network (which might be an intranet or internet) and data exchange is executed via an internet portal. As an advantage a client of the present system may work with a single browser and does not need to install complex software.

According to a further aspect of the present invention visualizing is executed by means of a process navigator, wherein visualized data is stored in a data base. Due to the storage of the visualized clinical process it is possible to use different filter operation to select specific data out of the data base. For example it is possible to get a representation of such steps within a clinical process that are assigned to a specific role (for example the role of a medical technical assistant or the role of a physician). Further, it is possible to have documentation with respect to each modification with respect to the implemented clinical process, so that any changes relating to the clinical process are deducible or may be tracked.

Yet according to another aspect of the present invention, designing is done with separate information technological modules, which substantially work independently of each other. The technological modules might be software modules, parts of software modules or a combined form of software and hardware modules. The technological modules are encapsulated and intrinsically un-associated units of functionality that have no calls or no interactions to each other embedded in them. For example, a technological module might refer to providing user interface for a detection of patient data. Another module might be a resource planner or a time planner or other modules might refer to diagnosis assistance etc. The interaction between the modules takes place via protocols. The steps of designing and modelling according to the present invention might also refer to “orchestration” which is a common term used within service oriented architecture (“SOA”).

According to another aspect of the present invention a method additionally may comprise another step. This step relates to a modification of the implemented clinical process. Any modifications within the modules and/or visualized clinical process are stored and documented automatically. Thus, any changes, modifications, additions or other amendments are traceable. As an advantage also an old status of the clinical process might be recovered or reproduced if it turns out that a new version of the same clinical process should not be accepted any more.

According to another aspect of the present invention modelling comprises accessing hierarchically structured data, consisting of different levels of detail, wherein data is stored in a data base. Due to the hierarchical structuring the user easily gets an overview of the implemented clinical process.

Generally, a large amount of input data or potential input data must be evaluated according to the relevant guidelines or guideline data before a qualified decision can be made. As the system according to the present invention is built of modules it is possible to consider newly added IT-resources newly added or modified software modules or to consider a new environment. It is also contemplated that the method and system of the present invention is suitable for use in a situation in which a next course of action must be determined. Further, it is possible to adapt an implemented clinical process for another environment or for another usage. For example an implementation of a clinical process in a radiology department easily could be adapted for an intensive care department. Some components of a design (the clinical process) can be borrowed from other designs whereas other components must be designed from scratch. Further, some implementation parameters might be reused, whereas other design and implementation parameters have to be adapted.

### BRIEF DESCRIPTION OF THE DRAWINGS

FIG. 1 shows an overview of process elements of the system of the present invention according to a preferred embodiment.

FIG. 2 shows diagram with different levels for use in the system of the present invention.

FIG. 3 shows a hierarchical overview with IT-workflows.

FIG. 4 is an overview of designing, modelling and visualizing.

FIG. 5 is a flowchart-like representation of the method of the present invention according to a preferred embodiment.

The following description of illustrated embodiments of the invention is not intended to be exhaustive or to limit the invention to precise form disclosed. Specific embodiments of, and examples for, the invention are described herein for illustrative purposes, whereas equivalent modifications are possible within the scope of the invention and can be made without the deviating from the scope of the invention.

For example, to some extent the description is based on structuring and implementing a clinical process. Alternatively, processes in any other fields or areas might possibly be used for the method and system according to the invention, like processes in a single department of clinical unit, processes in mechanical engineering, physics administration and management etc.

Further the method might be implemented in software, in coded form to be used in connection with a computer. Alternatively, it is possible to implement the method according to the invention in hardware or hardware modules. The hardware modules are then adapted to perform the functionality of the steps of the method described; furthermore it is possible to have a combination of hardware and software modules.

The present invention relates to a computer-implemented approach for implementing a guidance-based or evidence-based medical procedure within a clinical system. Implementing is assisted by a process navigator, which serves as a user interface for the implementation process.

As already noted a problem is to be seen in the large amount of guidance data which has to be evaluated for such an implementation process. For example in Germany there exist over several hundred guidance papers, one of which can have up to 300 or 400 pages. Up to now the process guidance based on evidence is not fully implemented in daily working conditions. Therefore the invention addresses a software-implemented assistance tool for such an implementation process for clinical guidelines. Further, the invention also transforms the input data (the guideline data) in such a format which is consistent and readable with/from the information technological modules.

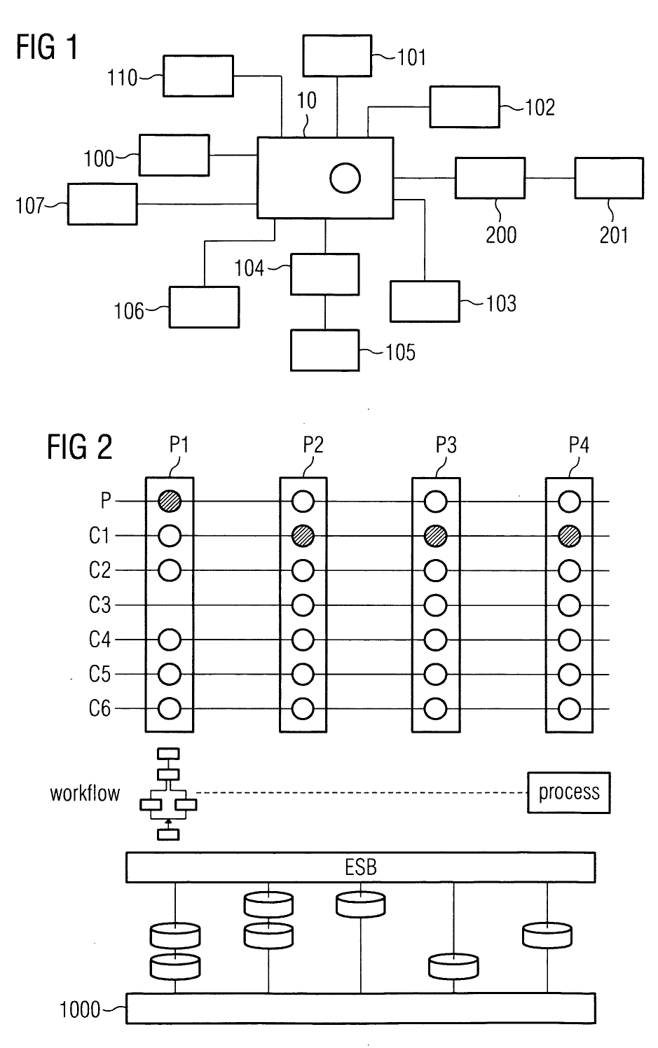

FIG. 1 shows an overview of possible elements, which all or in part might be realized and represented by software modules of the system for implementing a clinical process 10 according to a guideline 110.

As can be seen in FIG. 1 the inventive system uses a patient as an object in the clinical process 10 from the course of prevention and diagnosis to treatment and care. It can be seen that the patient being represented by the object plays a central role in the system according to the invention. The patient or the object respectively is depicted in FIG. 1 by a circle in the square, which represents the clinical process 10. Thus, it can be seen that the patient plays a central role for implementing the clinical process 10. Additionally, further object which are not depicted in FIG. 1 may be a product, a service, a medical professional, a partner, a client, an order, market, material, management system, information, finance, other data etc. Each object is assigned to a life cycle. The life cycle represents the quality enhancement of the respective object which means that for example a product has first a certain degree of quality, whereas the same product at a later date has a better quality. With other words the life cycle represents the quality enhancement of the respective object.

The process 10 of the object “patient” comprises several process steps, which might for example be: Prevention, diagnosis, therapy and care. For measuring the quality enhancement, there might be used known concepts or software tools in the state of the art which may be coupled to the system according to the invention. For example, there is the so called QALY-concept (which stands for quality adjusted live year).

The processes 10 are typically represented generically and are structured hierarchically. For example the structuring might be done by using the so called SCOR-modell (Supply Chain Operation Reference Modell). However, in an alternative embodiment also other concepts and other information technological moduls might be used in this stage. For example the process “diagnosis” might be structured in detail in:
detection of anamnesis data,
physiological examination,
structural examination,
consultation of medical professionals, perhaps in different roles (like doctor, nurse, etc.)
detecting clinical data and
detecting further data in respect to the diagnosis of the patient.

These above described processes might be further detailed and structured. For example the process step “physiological examination” might be further structured in:
capturing body liquid,
blood examination of the body liquid,
reporting the result,
feedback of the result.

Dependent on the actual use case these process steps may be further detailed, for example the process step “capturing body liquid” might be detailed in:
Defining the amount of liquid to be captured,
filling the captured liquid in an examination bin,
selecting the test to be applied,
testing the liquid,
receiving the result,
documenting the result.

The step of the process “documenting the result” might consist of the following steps:
testing the result,
forwarding the result as first result via telephone,
generating the report,
including the report in the patient file.

According to a preferred embodiment the level of detail is configurable. This means that a user might select how many levels of detail the process 10 shall have. Preferably, this is done by a rule out of a set of pre-definable rules. The rule says that not more that five process steps should exist on one level of detail, so that all processes have the same level of detail.

Referring again to FIG. 1 the system for implementation of the clinical process 10 has an input 100 and an output 200. The output 200 of the process 10 is defined by the object within the process 10 and by the process step. For example an output 200 might be: “diagnosis for patient is done” or “therapy of patient is done”. All process steps which lie beneath support this output 200.

In this respect it should be mentioned that there also might be a sequence of process steps to generate the process 10. Further, several processes 10 might be concatenated in order to establish a general superordinate mother process. In this case the output 200 of the process might be the input 100 of the next process.

As can be seen in FIG. 1 another parameter for the system is a description 101 of the process 10 to be implemented. The description 101 has the function to provide information with respect to the process 10 to specific steps of the process 10 or optionally to the general task or to the general idea of the specific process 10. The information should inform all participants of the process 10 in which way a specific term should be interpreted. Also in a health care context different participants or users might often use different vocabulary. Therefore, the invention also addresses the use of the vocabulary in that it uses a control vocabulary. For example the vocabulary might be controlled according to a standard. For example it could be adapted to be consistent with national library of medicine. In a preferred embodiment the system for example includes a help push button which enables the medical professional to select any area of system window to obtain sensitive or context-sensitive help messages and further meta information about the selected item.

A further parameter of the system is to be seen in a role 102. The role 102 is an important process element. There may be defined different roles for a user. For example there might be the role “responsible for the process”, “patient”, “rehab staff “,” control staff “,” research staff “,” clinical staff” or “intensive care staff”. Generally, a specific role 102 is assigned to a user of the system. Preferably, this assignment is a n:m relationship, which means that a specific user might have different roles 102 (for example the doctor himself might get ill and in this case will have the role “patient”) and also a specific role 102 might be assigned to different users (for example different doctors might be assigned to the role 102 “doctor”). It has to be mentioned that in a preferred embodiment the assignment of a role 120 to a person is not done within designing the process 10. The assignment is done in a separate process in order to separate the definition of competencies.

The representation of roles 102 might be done in a so called spaghetti diagram which is depicted on the upper part of FIG. 2. Here can be seen that different roles 102 might be assigned to different process steps like prevention P1, diagnosis P2, therapy P3 or care P4. On the left hand side of the diagram in FIG. 2 there are depicted different objects, like a patient P, an intensive care unit C1, a clinic C2, a rehab C3, a control C4, a telemedical centre C5 and a research centre C6. It has to be mentioned that these objects are only mentioned by way of example and thus, also additional departments or objects might be added or the objects mentioned above may be modified.

As further process elements there are the guidelines 110, which comprise standardized information with respect to the process to be implemented. The guidelines represent evidence-based medicine, standardized procedure in order to assist by implementing the process internal and external rules, norms, standards and information relating to good practice etc.

In FIG. 1 further process elements are depicted. A metric 201 may be used and methods and tools 103 also might be subject to the implementation process. Further, a template 104, a checklist 105 may also be used.

A further process element is standard operating procedures 106. The standard operating procedures 106 may be combined with specific work instructions, procedures, other standard operating procedures and workflows 107. All these process elements, mentioned above have to be construed as standard operating procedures 106. The standard operating procedures 106 may be used selectively, in case the generic description of the process is no longer sufficient, for example to comply with principles of law or to ensure a specific control of the process 10. The workflows 107 or standard operating procedures 106 use data out of different applications and combine these data for all users and participants of the process, so that they could access the information technological workflow 107.

FIG. 2 shows an overview of a combination of different process elements and the use of a central data base 1000 in order to combine different services. An enterprise service bus ESB is used, which accesses SOA-services, IT-services and/or ITIL-services, shown by way of example in FIG. 2 as different data bases. Preferably, the system according to the invention may be implemented in any suitable client server network environment such as a local area network (LAN) or a wide area network (WAN) or alternate types of internet work. Moreover, anyone of a variety of client-server architectures may be used, including but not limited to TCP/IP (HTTP network) or specifications like NAS and SAA. All modules of the system (clients and server) maybe interconnected by the enterprise service bus ESB. Further, there might be used a central or several data basis for storing and retrieving data related to the implementation of the process 10. Thus, the network may include a plurality of devices, such as server, routers and switching circuits connecting in a network configuration, as known by a person skilled in the art.

The user of the system for implementation of the process 10 may use a computer device, such as a personal computer (PC) a personal digital assistant (PDA) or other devices using wireless or wired communication protocols to access the other network modules and servers. The computer device might be coupled to I/O devices (not shown) that may include a keyboard in combination with a pointing device, such as a mouse to input data into the computer, a computer display screen and/or a printer to produce the output 200 of the process in paper form, a storage resource, such as a data base or repositories 1000 or hard disk drives for storing and retrieving data for the computer. In respect to the architecture of the computer system it has to be mentioned that the configuration may be modified. For example, multiple redundant servers could be implemented for both faster operations and enhanced reliability. Although, additional service could be used for various alternative functions (e.g. gateway functions) within the system.

Moreover, it has to be mentioned that all process element mentioned above and depicted in FIG. 1 may be realized and implemented by specific modules, particularly hardware modules. This means that the description 101 is implemented in a description module, the metric 201 is implemented within a metric module, the template 104 is implemented within a template module and so on. The modules themselves are realized by specific software modules and/or hardware modules to be connected to the system.

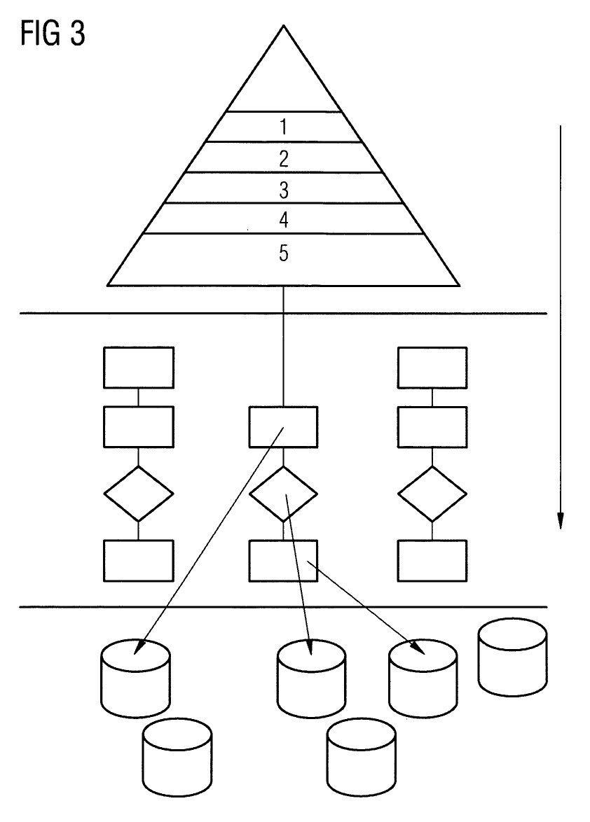

FIG. 3 shows the interaction of different modules of the system according to the invention. In the middle of the diagram shown in FIG. 3 there are shown different information technological workflows that use data out of different applications. These applications implement different business processes as represented by the triangle in the upper part of FIG. 3. A specific workflow is then realized and implemented by specific information technological applications which in FIG. 3 are shown on the bottom side of the diagram. The arrow in FIG. 3 pointing to the bottom represents the implementation process on an ongoing basis.

A further and essential concept of the present invention is to be seen that the implementation process is based on an architecture which separates the following functions:
designing 500
modelling 600 and
visualizing 700.

Preferably designing 500 uses all of the process elements which have been mentioned above and which are depicted in FIG. 1, like object, input 100, output 200, description 101, role 102, metric 201 and so on. Additionally, also more process element are also only a part of the above mentioned process elements might be used by designing 500. The designing 500 is based on all or a part of the following principles:
the process 10 defines the life cycle of an object;
the process is based on guidelines 110 or on evidence based medicine;
the process is structured hierarchically;
the process is only described so far as it is necessary; this is done by means of description module 101;
the process comprises roles 102 and no organisational units.

Normally the designing 500 is done manually by for example a flipchart. However, alternatively, it is also possible to make the designing 500 computer-assisted. For example a clinical path, which is implemented by specific IT-applications within a workflow, might assist the personal in finding the right decision and the right actions to take. Also standard operating procedures 106 or working instructions may be used for supporting the medical professionals. Sometimes the designing 500 might be based on specific tasks or actions in detail. There are defined specific steps and tasks within the context of, for example, disinfecting the skin before a medical operation. Whereas in other contexts it is not useful to have such a strict sequence of tasks. Here it is useful if the designing 500 might be as flexible as possible.

Generally, if there do exist several guidelines 110, for a specific process 10 or if there do exist a guideline 110 which comprises several different recommendations to implement the clinical process 10, then the system according to the invention is adapted that the clinic may decide which of the different guidelines or recommendations to be implemented for the process 10.

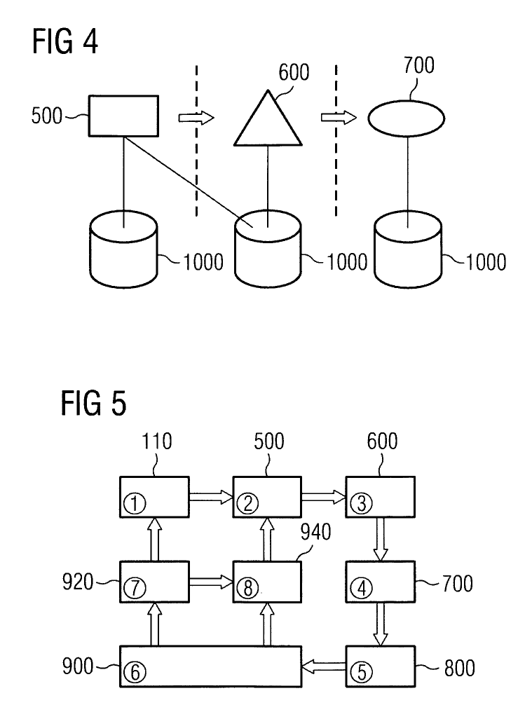

If designing 500 is supported by specific software, then the designing 500 might also make use of a specific repository 1000 which is not depicted in FIG. 4.

After designing 500 modelling 600 is executed. Modelling 600 may be supported by different IT-applications and modelling tools and by at least one repository 1000.

According to a preferred embodiment, modelling 600 also comprises a documentation of the modelled process 10. With this documentation feature or documentation tool it is possible to document any change with respect to modelling 600. A further advantage of documentation of the modelling process is that it is possible to have a “copy & paste”-action for single elements of the process of modelling 600. For example the orthopedical department of a clinic may also use the same modelling in certain aspects as another department of the clinic (for example the radiology) uses. In this case the modelling 600 or certain steps of the modelling 600 may be implemented in a workflow that is used by both units, the orthopedical unit and the radiology unit. The respective workflow might be accessed over a link out of the specific process 10.

Modelling 600 might be supported by modelling tools as known in the state of the art, such as ARIS of the company IDS Scheer or by any other tools known for a person skilled in the art.

As depicted in FIG. 4 after designing 500 and modelling 600 there is a visualization 700 of the modelled clinical process 10. Visualizing 700 may be done over internet portals which may be adapted user specific such as to represent the content specific for the process 10 to be carried out or specific to a user of the system. As depicted in FIG. 4 designing 500 may also access the data base 1000, which is used for modelling 600, in addition to the data base 1000, which usually is used for designing (and which is depicted direct under the rectangle which represents the process of designing 500).

According to a preferred embodiment visualizing 700 uses a so called process navigator in order to represent the process information for a user in practice. Normally, the output of modelling tools as known in the state of the art is represented difficult and complex to understand. Therefore, the invention makes use of a process navigator. The process navigator provides for a description 101 of the process 10 in the sense of a quality management system. Additionally, a user also might be provided with information with respect to the process 10 in form of a handbook. It is possible that visualizing 700 is done by accessing a repository 1000. In FIG. 4 there is only depicted one repository 1000 which might be accessed by designing 500, modelling 600 and visualizing 700. In another embodiment it is also possible to use separate repositories 1000 for designing 500, modelling 600 and visualizing 700 (not depicted in FIG. 4).

FIG. 5 shows an overview of the system for implementation the clinical process 10 and a basic version of a possible flowchart of the method according to the invention. With respect to FIG. 5 it has to be mentioned that the numbers in the rectangles represent the sequence of steps within the implementation process. Starting at the first rectangle depicted in FIG. 5 with the digit “1” guidelines 110 serve as input 100 of the system of the invention. The input 100 might also be based on standards, good practice or on other information with respect to the process to be implemented. As a next step there is designing 500 of the process. Then the process is modelled in step 600. Subsequent to the modelling the modelled clinical process 10 is visualized during visualizing 700. According to a basic version of the system, the method may end here. Additionally it is possible to have further steps to be executed subsequently.

For example it is possible to have a training 800 or further education steps. All users of the process navigator will be educated and trained in using the process navigator in order to learn how to manage the elements of the implementation process.

In parallel or subsequent to training 800 there might be an application 900 of the implementation process. Applying 900 the process navigator in daily practice provides possibilities for enhancement or a basis for changes.

In 920 the derived knowledge might be documented. All results of the implementation process might be stored for possible benchmarking processes.

It is also possible that it is necessary to change the implementation process. Changing 940 the implementation process might easily be done as all process elements are combined modularly. In case there is a changing 940 of the process 10 then the method starts again by designing 500 the process 10. Additionally, it is also possible that there are changes with respect to the guidelines 110. In this case also the process starts again with designing 500.

An advantage of the system and the method according to the invention with the process navigator is the provision of evidence-based medical knowledge being refined with hospital department and economic specific information, linked to IT-application in order to support the processes. For example the IT-applications might be adapted to be used in surgery room, in an intensive care unit or in an emergency room. By using a top down description of processes 10, starting with generic processes, it is easy for a user to adjust the content of the navigator to a specific medical department taking into account the results of evidences in a specific medical domain. The implementation process is divided into three separate steps: designing 500, modelling 600 and visualizing 700 which are executed independently of each other and which are built up in a modular manner.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

### REFERENCE NUMERALS

10 process
110 guidelines
101 description
102 role
100 input
103 method tools
104 template
105 checklist
106 standard operating procedures
107 information technological based workflow
200 output
201 metric
500 designing
600 modelling
700 visualizing
800 training
900 application
920 derived knowledge
940 changing
1000 repository/data base
P Patient
C1 intensive care
C2 clinic
C3 rehab
C4 control
C5 telemedical center
C6 research
ESB enterprise service bus

1. A computer implemented method for implementing a clinical process according to a guideline, comprising:
providing a set of guidelines,
selecting guideline data out of the set of guidelines, being relevant for the clinical process,
designing the clinical process, based on the selected guideline data,
modelling the designed clinical process,
visualizing the modelled clinical process, whereby designing, modelling and visualizing are executed independently of each other and wherein the modelled clinical process is structured procedurally.

2. A method according to claim 1, wherein the method is based on a service oriented architecture in order to generate the process.

3. A method according to claim 1, wherein guideline data or guidelines serve as input of the method and wherein an output comprises workflow oriented knowledge with respect to the clinical process, based on guideline data or guidelines.

4. A method according to claim 3, wherein the output comprises additional information with respect to the clinical process, standard operating procedures or specific operating instructions.

5. A method according to claim 1, wherein visualizing is done by means of a single template for inputting and outputting data, wherein inputting and outputting might be done over a network interface, particularly an internet portal.

6. A method according to claim 1, wherein visualizing is executed by means of a process navigator, wherein visualized data is stored in a data base.

7. A method according to claim 1, wherein designing and modelling is done with separate information technological modules, which substantially work independently of each other.

8. A method according to claim 1, wherein the method further comprises the step of:
changing the modelled process, while any changes are documented automatically.

9. A method according to claim 1, wherein modelling comprises accessing hierarchically structured data, consisting of different levels of detail, wherein data is stored in a data base.

10. A method according to claim 1, wherein the method further comprises:
transforming guideline data in a data format, being consistent with and readable from information technological modules, being used for implementation of the clinical process.

11. Computerized system for implementing a clinical process according to a guideline comprising:
a network with different information technological modules,
a guideline module which is adapted to provide a set of guidelines and to select guideline data out of the set of guidelines, being relevant for the clinical process,
design engine, which is adapted to design the clinical process based on the selected guideline data of the guideline module,
a modelling engine, which is adapted to modell the designed clinical process of the designed engine,
a visualizing engine, which is adapted to visualize the modelled clinical process of the modelling engine, whereby the design engine, the modelling engine and the visualizing engine are separate modules and are executed independently of each other and wherein the visualizing engine is adapted to visualize the modelled clinical process in structured procedural form, being based on the guidelines of the guideline module.

12. Computer readable medium having thereon computer-executable instructions for executing a method, if that program is loaded on to a computer, wherein the method is adapted for implementing a clinical process according to a guideline, comprising:
providing a set of guidelines,
selecting guideline data out of the set of guidelines, being relevant for the clinical process,
designing the clinical process, based on the selected guideline data,
modelling the designed clinical process,
visualizing the modelled clinical process, whereby designing, modelling and visualizing are executed independently of each other and wherein the modelled clinical process is structured procedurally.

13. Computer readable medium having thereon computer-executable instructions for executing a method, if that program is loaded on to a computer, wherein the method is adapted for implementing a clinical process according to a guideline, comprising:
providing a set of guidelines,
selecting guideline data out of the set of guidelines, being relevant for the clinical process,
designing the clinical process, based on the selected guideline data,
modelling the designed clinical process,
visualizing the modelled clinical process, whereby designing, modelling and visualizing are executed independently of each other and wherein the modelled clinical process is structured procedurally.
